(19) United States
(12) Patent Application Publication
(10) Pub. No.: US 2026/0267170 A1
(43) Pub. Date: Sep. 10, 2026

(54) AUDIO GLASSES DEVICE

(71) Applicant: Harman International Industries, Incorporated, Stamford, CT (US)

(72) Inventors: Shaomin WANG, Shenzhen (CN); Guotao YUAN, Shenzhen (CN)

(73) Assignee: Harman International Industries, Incorporated, Stamford, CT (US)

(21) Appl. No.: 19/666,450

(22) Filed: May 4, 2026

Related U.S. Application Data
(63) Continuation of application No. PCT/CN2023/132634, filed on Nov. 20, 2023.

(51) Int. Cl. G02C 11/00; H04R 1/02; H04R 1/10; H04R 9/06

(52) U.S. Cl. CPC G02C 11/10; H04R 1/028; H04R 1/1008; H04R 1/1075; H04R 9/06; H04R 2460/11

(57) ABSTRACT

An audio glasses device is provided. The audio glasses device includes a glasses frame, at least one glasses temple pivotally connected to the glasses frame via a hinge, a speaker unit located in the glasses temple, an audio outlet, and an acoustic venting hole. The speaker unit includes a diaphragm. The audio outlet is located in the glasses temple and in communication with a front space in front of the diaphragm. The acoustic venting hole is located in the glasses temple and in communication with a rear space behind the diaphragm. The acoustic venting hole is positioned proximate to the hinge and positioned opposing and spaced apart from the glasses frame.

### CROSS-REFERENCE TO RELATED APPLICATIONS

This application is a continuation of International Application No. PCT/CN 2023/132634, filed on Nov. 20, 2023. The disclosures of the above application are incorporated herein by reference.

### FIELD

The present disclosure relates to an audio glasses device, and specifically to an audio glasses device having an acoustic venting hole.

### BACKGROUND

The statements in this section merely provide background information related to the present disclosure and may not constitute prior art.

Audio glasses devices, which integrate eyewear and audio technology, have gained popularity for their dual functionality. In scenarios where the audio glasses are used, including outdoor activities and daily wear, they often encounter situations involving rain or exposure to water. The rain and exposure to water present a challenge: maintaining high-quality audio performance, particularly in low-frequency range, within a confined space of an audio glasses device, while providing effective waterproof capabilities.

Conventional designs of audio glasses devices often face difficulties in achieving a balance between these two essential features. Due to the limited space within the audio glasses devices, producing high-quality audio output in low-frequency range is a common challenge. In many cases, the solutions implemented to protect against water ingress often lead to a degradation in sound performance, especially in low-frequency audio performance, resulting in compromises in either sound quality or water resistance. This challenge is an issue in the design of audio glasses and improving user experience.

Therefore, there is a need for audio glasses devices that can maintain high-quality audio performance, especially in low-frequency range, while providing effective waterproof capabilities.

### SUMMARY

This section provides a general summary of the disclosure and is not a comprehensive disclosure of its full scope or all of its features.

According to one aspect of the disclosure, an audio glasses device is provided. The glasses device comprises a glasses frame, at least one glasses temple pivotally connected to the glasses frame via a hinge; a speaker unit located in the glasses temple, an audio outlet, and an acoustic venting hole. The speaker unit comprises a diaphragm. The audio outlet located in the glasses temple and in communication with a front space in front of the diaphragm. The acoustic venting hole is located in the glasses temple and in communication with a rear space behind the diaphragm. The acoustic venting hole is positioned proximate to the hinge and positioned opposing and spaced apart from the glasses frame.

### DRAWINGS

In order that the disclosure may be well understood, there will now be described various forms thereof, given by way of example, reference being made to the accompanying drawings, in which:

FIG. 1A illustrates a perspective view of an audio glasses device according to one or more embodiments of the present disclosure;

FIG. 1B is a perspective view of the audio glasses device of FIG. 1A, with a portion of the housing of one glasses temple being removed to reveal an internal structure;

FIG. 2A is a partially enlarged view of the internal structure of the audio glasses device of FIG. 1B;

FIG. 2B is a partially enlarged view of the internal structure of the audio glasses device of FIG. 1B with a printed circuit board (PCB) removed from a PCB chamber for clarity;

FIG. 3A is a perspective view of an audio glasses device according to one or more embodiments of the present disclosure;

FIG. 3B is an enlarged view of area 3B of the audio glasses device in FIG. 3A;

FIG. 4A is a cross-sectional view of an audio glasses device according to one or more embodiments of the present disclosure;

FIG. 4B is an enlarged view of area 4B of the audio glasses device in FIG. 4A;

FIG. 5A is a perspective view of a glasses temple of an audio glasses device according to one or more embodiments of the present disclosure;

FIG. 5B is a cross-sectional view of a portion of the glasses temple of the audio glasses device shown from a direction indicated by an arrow 5B in FIG. 5A; and

FIG. 6 illustrates a frequency response comparison between an audio glasses device according to one or more embodiments and an audio glasses device according to a comparative embodiment.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure provides an audio glasses device. The audio glasses device comprises a speaker unit located in the glasses temple. Additionally, the audio glasses device includes an acoustic venting hole located in the glasses temple and in communication with a rear space behind a diaphragm of the speaker unit. The acoustic venting hole is positioned proximate to the hinge of the audio glasses device and opposing and spaced apart from the glasses frame of the audio glasses device.

By this configuration, the acoustic venting hole can be naturally shielded by the hinge structure from rainwater or splashes, reducing the risk of water ingress to electric elements located within the glasses temple. The acoustic venting hole, which is in communication with the rear space behind the diaphragm of the speaker unit, can effectively balance the pressure inside the glasses temple, thereby improving sound performance, especially in a low-frequency range.

In one or more embodiments, the acoustic venting hole comprises an outer hole segment and an inner chamber segment having a cross-sectional area larger than the outer hole segment. The audio glasses device further comprises a mesh covering the inner chamber segment.

The increased cross-sectional area of the inner chamber segment allows the mesh to have a greater surface area for sound or air to pass through, compensating for the mesh's relatively lower permeability compared to the open outer hole segment. Thus, the configuration improves audio performance by facilitating effective sound transmission, while maintaining a relatively small cross-sectional area of the outer hole segment, thereby effectively balancing the need for waterproofing with the requirement for high-quality audio performance.

In one or more embodiments, the audio glasses device further comprises a printed circuit board (PCB) chamber located in the glasses temple. The PCB chamber houses a PCB and electronic components, and is positioned between the speaker unit and the hinge. The PCB chamber, along with the rear space, together constitute at least a portion of the rear acoustic volume of the speaker unit.

This configuration, which incorporates the PCB chamber into the rear acoustic volume of the speaker unit, efficiently utilizes the free space in the PCB chamber, and increases the rear acoustic volume of the speaker unit, allowing for an improved audio performance of speaker unit, especially in low-frequency range.

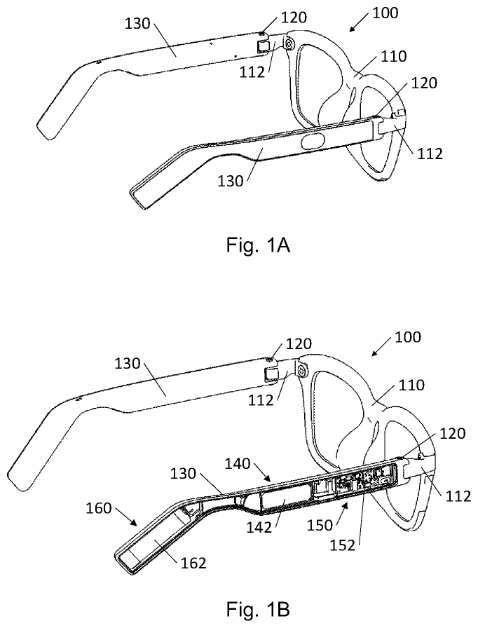

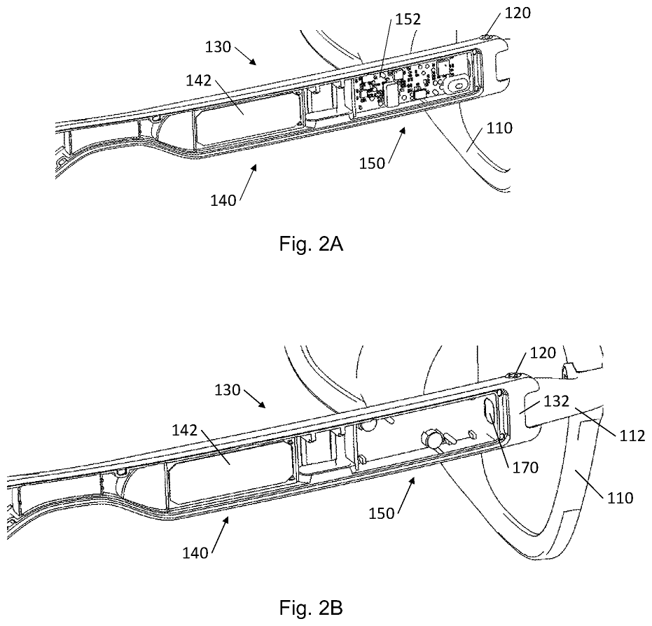

FIG. 1A illustrates a perspective view of an audio glasses device 100 according to one or more embodiments of the present disclosure. FIG. 1B is a perspective view similar to FIG. 1A, with a portion of the housing of one of the glasses temples 130 being removed to reveal the inner or internal structure of the glasses temple 130. The audio glasses device 100 comprises a glasses frame 110 and two glasses temples 130. The glasses frame 110 comprises a frame body and two endpieces 112, either fixedly connected to or integral with the frame body. Each glasses temple 130 is pivotally connected to a respective endpiece 112 of the glasses frame 110 via a hinge 120. Each glasses temple 130 comprises a speaker unit 142 (FIG. 1B) for producing an audio output, a PCB 152 (FIG. 1B) having electric elements mounted thereon and configured to generate an electric audio signal for driving the speaker unit 142, and a battery 162 (FIG. 2) configured to supply power to the electric elements. Each glasses temple 130 is also formed with a speaker chamber 140 containing the speaker unit 142, the PCB chamber 150 containing the PCB 152 and the electric elements thereon, and a battery chamber 160 containing the battery 162. In one or more embodiments shown, the two glasses temples 130 are symmetrically arranged or configured, and thus the description provided in relation to one glasses temple can also be applied to the other glasses temple.

FIG. 2A is a partially enlarged view of FIG. 1B, showing the internal structure of the glasses temple 130. FIG. 2B is a view similar to FIG. 2A, with the PCB 152 removed from the PCB chamber 150 to reveal the structure of the PCB chamber. As shown in FIG. 2B, an acoustic venting hole 170 is formed in an end portion 132 of the glasses temple 130. The end portion 132 defines a portion of the PCB chamber 150, and the acoustic venting hole 170 formed therein is in direct communication with the PCB chamber 150.

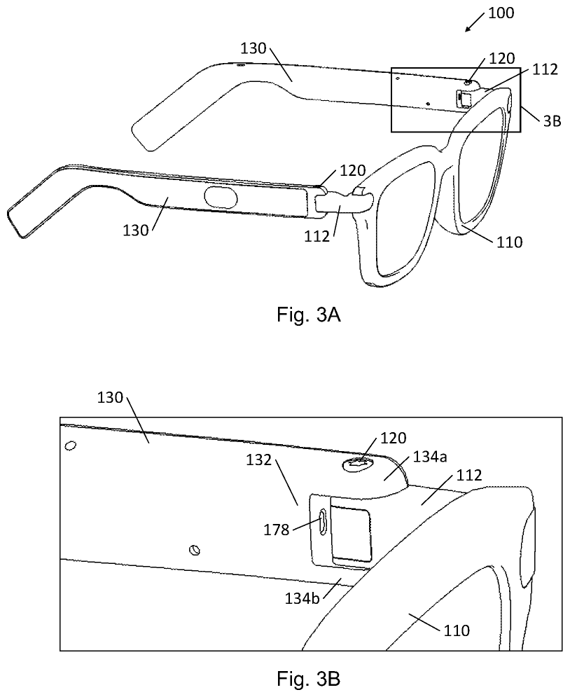

FIG. 3A illustrates a perspective view of an audio glasses device 100 according to one or more embodiments of the present disclosure. FIG. 3B is an enlarged view of area 3B in FIG. 3A. As shown, the glasses temple 130 is pivotally connected to a respective endpiece 112 of the glasses frame 110 at its end portion 132 (FIG. 3B). Specifically, the glasses temple 130 comprises an upper extension 134a and a lower extension 134b extending from its end portion 132. The endpiece 112 of the glasses frame 110 is situated between the upper extension 134a and the lower extension 134b and is pivotally connected to the upper extension 134a and the lower extension 134b via the hinge 120. The acoustic venting hole 170, located in the end portion 132, is positioned opposing the endpiece 112, and has an outer port 178 nestled between the upper extension 134a and the lower extension 134b. In this configuration, the end portion 132, the upper extension 134a and the lower extension 134b of the glasses temple 130, the endpiece 112 of the glasses frame 110 naturally shield the outer port 178 of the acoustic venting hole 170 from rainwater or splashes, reducing the risk of water ingress and potential damage to the PCB 152 or electric elements located within the glasses temple 130. Additionally, the acoustic venting hole 170, which is in communication with a rear space behind a diaphragm of the speaker unit 142, can effectively balance the pressure inside the chamber (rear acoustic volume), thereby improving sound performance, especially in a low-frequency range. The configuration also provides an aesthetic appearance for the audio glasses device 100 as the acoustic venting hole 170 is not visible from most angles.

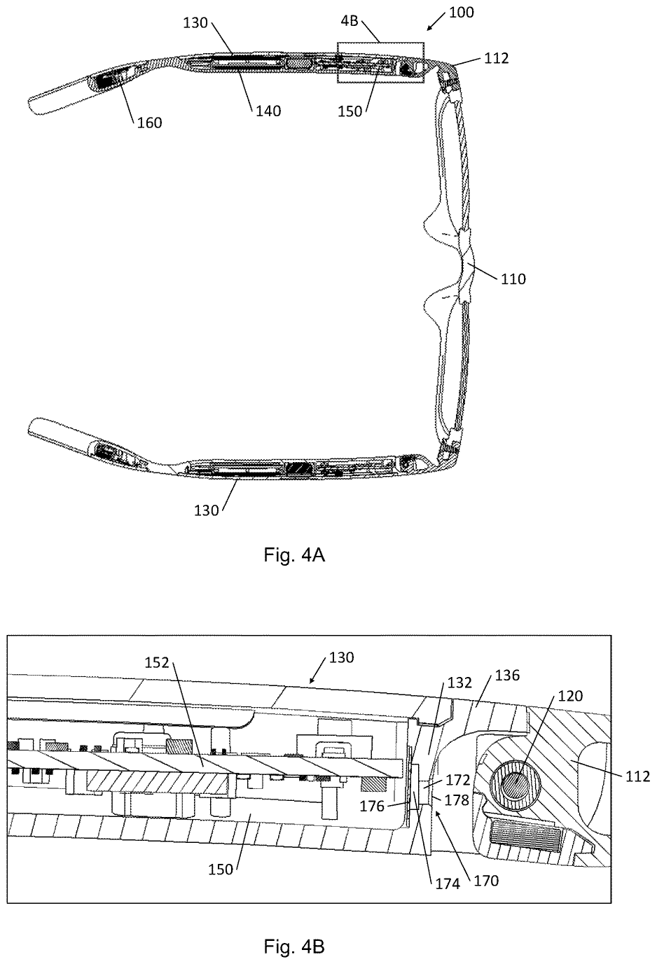

FIG. 4A illustrates a cross-sectional view of an audio glasses device 100 according to one or more embodiments of the present disclosure. FIG. 4B is an enlarged view of area 4B in FIG. 4A. As shown, the glasses temple 130 is formed with an outer lateral extension 136 extending from its end portion 132 (FIG. 4B). This outer lateral extension 136 functions to limit the pivotal angle of the glasses temple 130 relative to the glasses frame 110. The outer lateral extension 136 also functions to shield the outer port 178 of the acoustic venting hole 170 from rainwater or splashes, in conjunction with the end portion 132, the upper extension 134a and the lower extension 134b of the glasses temple 130, and the endpiece 112 of the glasses frame 110. In other words, the acoustic venting hole 170 is in communication with a space surrounded by the end portion 132, the upper extension 134a, the lower extension 134b, the outer lateral extension 136, and the endpiece 112. This configuration contributes to a reduced water ingress risk to the PCB or electric elements located within the glasses temple 130.

The acoustic venting hole 170 comprises an outer hole segment 172 opposing the endpiece 112 and an inner chamber segment 174 in communication with the PCB chamber 150. The inner chamber segment 174 has a cross-sectional area larger than that of the outer hole segment 172. The audio glasses device 100 further comprises a mesh, specifically a waterproof mesh 176, covering the inner chamber segment 174.

The configuration of the acoustic venting hole 170, with the inner chamber segment 174 being larger than the outer hole segment 172 and covered by the mesh or waterproof mesh 176, improves audio performance by facilitating effective sound transmission. The increased cross-sectional area of the inner chamber segment 174 allows the mesh or waterproof mesh 176 to have a greater surface area for sound or air to pass through, compensating for the mesh's relatively lower permeability compared to the open outer hole segment 172. This configuration maintains sound quality while providing the desired waterproofing, thereby effectively balancing the need for waterproofing with the desirability for high-quality audio performance.

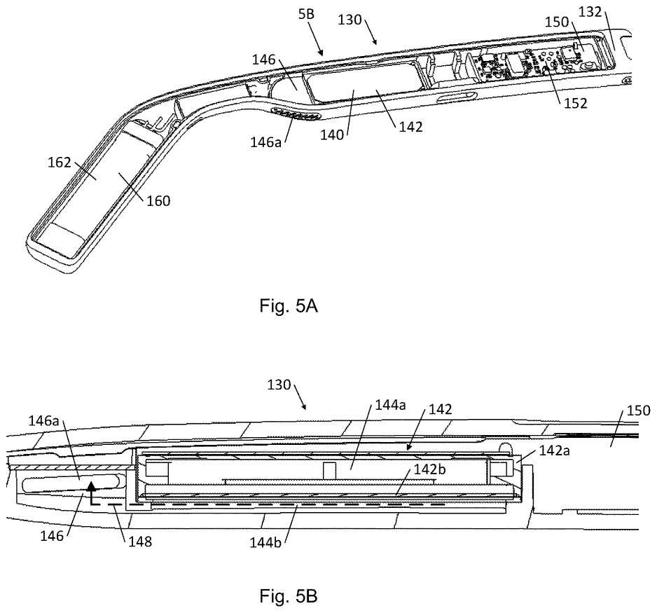

FIG. 5A illustrates a perspective view of a glasses temple 130 of an audio glasses device 100 according to one or more embodiments of the present disclosure. FIG. 5B shows a cross-sectional view as seen from a direction indicated by an arrow 5B in FIG. 5A. The glasses temple 130 is formed therein with a speaker chamber 140 containing a speaker unit 142, a PCB chamber 150 containing a PCB 152 and electric elements, and a battery chamber 160 containing a battery 162. The PCB chamber 150 is located adjacent to the end portion 132 of the glasses temple 130 and is in direct communication with the acoustic venting hole 170 (shown in FIG. 4B). The battery chamber 160 is located distal to the end portion 132. The speaker chamber 140 is located between the PCB chamber 150 and the battery chamber 160.

As shown in FIG. 5B, the speaker unit 142, which is housed within the speaker chamber 140, comprises a speaker frame 142a and a diaphragm 142b affixed to the speaker frame 142a. The speaker unit 142 also comprises a magnetic assembly attached to the speaker frame 142a and a voice coil attached to the diaphragm 142b. The space or area behind the diaphragm 142b is designated as a rear space 144a and the space or area in front of the diaphragm 142b is designated as a front space 144b. The glasses temple 130 is also formed with an audio output chamber 146 that is located adjacent to the speaker chamber 140 and in communication with the front space 144b. An audio outlet 146a is formed in the audio output chamber 146, allowing sound to be transmitted from the audio output chamber 146 to outside of the audio glasses device 100. During operation, the diaphragm 142b vibrates in response to an electric audio signal transmitted to the speaker unit 142. The sound generated by the diaphragm 142b travels to the front space 144b, following a path indicated by the dotted arrow 148, into the audio output chamber 146, and then emitted from the audio glasses device 100 through the audio outlet 146a.

The rear space 144a is in communication with the PCB chamber 150, which in turn is in direct communication with the acoustic venting hole 170 (shown in FIG. 4B). Consequently, the rear space 144a and the PCB chamber 150 may collectively contribute to the rear acoustic volume of the speaker unit 142. This configuration, which incorporates the PCB chamber 150 into the rear acoustic volume of the speaker unit 142, efficiently utilizes the internal space of the glasses temple 130, such as the free space in the PCB chamber 150, and increases the rear acoustic volume of the speaker unit 142. This allows for increased air movement and vibration, and thus significantly enhances the audio performance of speaker unit 142, especially in low-frequency range.

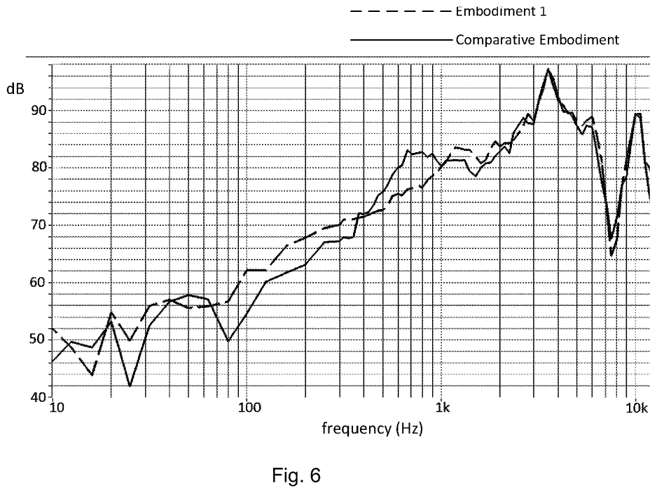

FIG. 6 illustrates a frequency response comparison between an audio glasses device according to embodiment 1 and an audio glasses device according to a comparative embodiment. The audio glasses device according to embodiment 1 has a structure or configuration similar to those shown in FIG. 1A-FIG. 5B and comprises an acoustic venting hole, while the audio glasses device according to the comparative embodiment has a structure or configuration similar to that of the embodiment 1, but without an acoustic venting hole. The dashed line represents a frequency response of the glasses device according to embodiment 1, which shows a notable enhancement in low-frequency performance, particularly in the 100-300 Hz range. For instance, there is an improvement of 7.5 dB at 100 Hz and 4.5 dB at 200 Hz in sound output level as compared to the comparative embodiment, as depicted by the solid line. The enhanced low-frequency response, as illustrated in FIG. 6, is due to the acoustic venting hole in embodiment 1, which facilitates a more balanced sound pressure level and the low-frequency audio performance.

In one or more embodiments shown, the two glasses temples 130 are symmetrically arranged or configured and both of the glasses temples 130 are formed with a speaker unit 142 and thus can generate an audio output. In one or more other embodiments, only one of the glasses temples 130 is provided with a speaker unit and can generate an audio output.

According to one or more embodiments of the disclosure, the present disclosure can be implemented as follows.
Item 1: An audio glasses device, comprising: a glasses frame; at least one glasses temple pivotally connected to the glasses frame via a hinge; a speaker unit located in the glasses temple, the speaker unit comprising a diaphragm; an audio outlet located in the glasses temple and in communication with a front space in front of the diaphragm; and an acoustic venting hole located in the glasses temple and in communication with a rear space behind the diaphragm, wherein the acoustic venting hole is positioned proximate to the hinge and positioned opposing and spaced apart from the glasses frame.
Item 2: The audio glasses device according to Item 1, wherein the audio glasses device further comprises a rear acoustic volume in the glasses temple and in communication with the rear space behind the diaphragm, the acoustic venting hole being in communication with the rear space behind the diaphragm via the rear acoustic volume.
Item 3: The audio glasses device according to any one of Items 1-2, wherein the audio glasses device further comprises a PCB chamber located in the glasses temple and housing a PCB and electronic components, the PCB chamber is located between the speaker unit and the hinge, with the PCB chamber and the rear space collectively constituting at least a part of the rear acoustic volume.
Item 4: The audio glasses device according to any one of Items 1-3, wherein the audio glasses device further comprises a battery chamber and a speaker chamber located in the glasses temple, the PCB chamber is located proximate to the hinge, while the battery chamber is located distal to the hinge, and the speaker chamber is located between the PCB chamber and the battery chamber.
Item 5: The audio glasses device according to any one of Items 1-4, wherein the acoustic venting hole is located in an end portion of the glasses temple, and is in direct communication with the PCB chamber.
Item 6: The audio glasses device according to any one of Items 1-5, wherein the audio glasses device further comprises an audio output chamber that is in communication with the front space and is located between the speaker chamber and the battery chamber, the audio outlet is formed in the audio output chamber, allowing sound transmitted from the audio output chamber to outside of the audio glasses device.
Item 7: The audio glasses device according to any one of Items 1-6, wherein the acoustic venting hole comprises an outer hole segment and an inner chamber segment having a cross-sectional area larger than the outer hole segment, the audio glasses device further comprises a mesh covering the inner chamber segment.
Item 8: The audio glasses device according to any one of Items 1-7, wherein the speaker unit comprises a magnetic assembly and a voice coil located behind the diaphragm.
Item 9: The audio glasses device according to any one of Items 1-8, wherein the glasses frame comprises a frame body and at least one endpiece extending from the frame body, each glasses temple comprises an end portion having an upper extension and a lower extension extending therefrom and pivotally connected to the endpiece, the acoustic venting hole being located in the end portion and having an outer port nestled between the upper extension and the lower extension.
Item 10: The audio glasses device according to any one of Items 1-9, wherein the end portion of the glasses temple further comprises an outer lateral extension extending therefrom, the acoustic venting hole being in communication with a space surrounded by the end portion, the upper extension, the lower extension, the outer lateral extension, and the endpiece.
Item 11: The audio glasses device according to any one of Items 1-10, wherein the at least one glasses temple comprises two glasses temples, each with a speaker unit located therein.
Item 12: The audio glasses device according to any one of Items 1-11, wherein the glasses frame comprises a frame body and two endpieces extending from the frame body, each of the two glasses temples being pivotally connected to a corresponding endpiece via a hinge, each acoustic venting hole being positioned opposing its corresponding endpiece.

Systems and methods have been described in general terms as an aid to understanding details of the disclosure. In some instances, well-known structures, materials, and/or operations have not been specifically shown or described in detail to prevent obscuring aspects of the disclosure. In other instances, specific details have been given to provide a thorough understanding of the disclosure. One skilled in the relevant art will recognize that the disclosure may be embodied in other specific forms, for example to adapt to a particular system or apparatus or situation or material or component, without departing from the spirit or essential characteristics thereof. Therefore, the disclosures and descriptions herein are intended to be illustrative, but not limiting, of the scope of the disclosure. Accordingly, the disclosure is not to be restricted except considering the attached claims and their equivalents

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the singular forms “a”, “an” and “the” are intended to include the plural forms as well, unless the context clearly indicates otherwise. The terms “comprise”, “comprising”, “include” and/or “including”, as used herein, specify the presence of stated features, integers, steps, operations, elements, and/or components, but do not preclude the presence or addition of one or more other features, integers, steps, operations, elements, components, and/or combinations thereof. As used herein, the term “and/or” and the symbol “/” are meant to include any and all combinations of one or more of the associated listed items. Additionally, while the terms first, second etc., may be used herein to describe various elements, components, steps or calculations, these elements, components, steps, or calculations should not be limited by these terms, rather, these terms are only used to distinguish one element, component, step, or calculation from another. For example, a first component may be referred to as a second component, similarly a first calculation may be referred to as a second calculation; likewise, a first step may be referred to as a second step, all without departing from the scope of this disclosure.

As used herein, the phrase at least one of A, B, and C should be construed to mean a logical (A OR B OR C), using a non-exclusive logical OR, and should not be construed.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An audio glasses device, comprising:
a glasses frame;
at least one glasses temple pivotally connected to the glasses frame via a hinge;
a speaker unit located in the at least one glasses temple, the speaker unit comprising a diaphragm;
an audio outlet located in the at least one glasses temple and in communication with a front space in front of the diaphragm; and
an acoustic venting hole located in the at least one glasses temple and in communication with a rear space behind the diaphragm, wherein the acoustic venting hole is positioned proximate to the hinge and positioned opposing and spaced apart from the glasses frame.

2. The audio glasses device according to claim 1, further comprising a rear acoustic volume in the at least one glasses temple and in communication with the rear space behind the diaphragm, the acoustic venting hole being in communication with the rear space behind the diaphragm via the rear acoustic volume.

3. The audio glasses device according to claim 2, further comprising a PCB chamber located in the at least one glasses temple and housing a PCB and electronic components, the PCB chamber is located between the speaker unit and the hinge with the PCB chamber and the rear space collectively constituting at least a part of the rear acoustic volume.

4. The audio glasses device according to claim 3, further comprising a battery chamber and a speaker chamber located in the at least one glasses temple, the PCB chamber is located proximate to the hinge, while the battery chamber is located distal to the hinge, and the speaker chamber is located between the PCB chamber and the battery chamber.

5. The audio glasses device according to claim 4, wherein the acoustic venting hole is located in an end portion of the at least one glasses temple, and is in direct communication with the PCB chamber.

6. The audio glasses device according to claim 4, further comprising an audio output chamber that is in communication with the front space and is located between the speaker chamber and the battery chamber, the audio outlet is formed in the audio output chamber, allowing sound transmitted from the audio output chamber to outside of the audio glasses device.

7. The audio glasses device according to claim 1, wherein the acoustic venting hole comprises an outer hole segment and an inner chamber segment having a cross-sectional area larger than the outer hole segment, the audio glasses device further comprises a mesh covering the inner chamber segment.

8. The audio glasses device according to claim 1, wherein the speaker unit comprises a magnetic assembly and a voice coil located behind the diaphragm.

9. The audio glasses device according to claim 1, wherein the glasses frame comprises a frame body and at least one endpiece extending from the frame body, each glasses temple comprises an end portion having an upper extension and a lower extension extending therefrom and pivotally connected to the at least one endpiece, the acoustic venting hole being located in the end portion and having an outer port nestled between the upper extension and the lower extension.

10. The audio glasses device according to claim 9, wherein the end portion of each glasses temple further comprises an outer lateral extension extending therefrom, the acoustic venting hole being in communication with a space surrounded by the end portion, the upper extension, the lower extension, the outer lateral extension, and the at least one endpiece.

11. The audio glasses device according to claim 1, wherein the at least one glasses temple comprises two glasses temples, each of the two glasses temples with a speaker unit located therein.

12. The audio glasses device according to claim 11, wherein the glasses frame comprises a frame body and two endpieces extending from the frame body, each of the two glasses temples being pivotally connected to a corresponding endpiece via a hinge, each acoustic venting hole being positioned opposing its corresponding endpiece.
